(19) United States
(12) Patent Application Publication
(10) Pub. No.: US 2024/0217490 A1
(43) Pub. Date: Jul. 4, 2024

(54) Electric Lift Apparatus for Trailer Bed Legs

(71) Applicant: Cedrick LaMont Dale, Dumfries, VA (US)

(72) Inventor: Cedrick LaMont Dale, Dumfries, VA (US)

(21) Appl. No.: 18/401,081

(22) Filed: Dec. 29, 2023

Related U.S. Application Data
(60) Provisional application No. 63/477,767, filed on Dec. 29, 2022.

(51) Int. Cl. B60S 13/00

(52) U.S. Cl. CPC B60S 13/00

(57) ABSTRACT

The present invention provides a portable electric lift apparatus for trailer bed legs. The electric lift apparatus comprises a housing unit and a control module. The housing unit includes a motor, a battery source which is electrically connected to the motor, a sleeve, and a connection tube attached to the sleeve. The sleeve has teeth located in the circumstances of the sleeve and the connection tube has teeth located in one end of the tube. The teeth on the connection tube are meshed with the teeth of the sleeve. The control module includes multiple control buttons, one of the buttons controlling an upper ward lifting movement of the lift apparatus and another one of the buttons is for controlling a downward movement of the lift apparatus.

### CROSS REFERENCE TO RELATED APPLICATIONS

The present application claims priority to U.S. Provisional Patent Application Ser. No. 61/368,889 filed on Dec. 29, 2022, the contents of which are incorporated herein by reference.

### FIELD OF THE INVENTION

The present invention relates generally to trailer bed lift(s). More specifically, the present invention is an electric lift apparatus for trailer bed legs.

### BACKGROUND OF THE INVENTION

Currently, delivery or transportation of goods by trailer trucks is a common facet of present society. Due to the nature of how most trailer trucks are designed, legs are often required to stabilize the trailer beds of the vehicles during loading/unloading of goods from the trailer beds. These legs are often stowed away underneath the trailer bed while the vehicle is in transport, and then released when the vehicle is being loaded or off-loaded. In order to release the legs from underneath the trailer bed, often times, the user has to manually release the legs through the use of a crankshaft similarly like how one would use a car jack. However, this can cause physical strain on the user's body. Instead, the user could install an electric lift attached to the legs of the trailer bed. However, these electric lifts are not universally applicable to all trailer beds. Also, these electric lifts can only be accessed at the legs of the trailer bed; making it difficult for the user to lower or raise the legs at a singular rate or at the same time. Additionally, in using these electric lifts, the user is not able to choose between raising and/or lowering the legs electrically or manually.

An objective of the present invention is to provide users with a device that can be an electric lift apparatus for trailer bed legs. The present invention intends to provide users with a device that can be attached to the trailer bed near to the legs of the trailer bed. The present invention intends to provide users with a device that allows the user to electrically or manually raise/lower the legs of the trailer bed. The present invention intends to provide users with a device that allows the user to conveniently raise and lower the legs of the trailer bed at an efficient location.

### SUMMARY OF THE INVENTION

The present invention is related to an electric lift apparatus for trailer bed legs. One objective of the present invention is to provide an electric lift apparatus that comprises a housing unit and a control module. The housing unit includes a motor, a connection tube, a sleeve, and a battery source. The motor is located at or near to where the crankshaft would be attached to raise or lower the trailer bed leg. The apparatus of the present invention includes a sleeve with teeth such that teeth of the sleeve mesh with the teeth of the driveshaft of the motor; much like how gears work. The sleeve is attached to a connection rod of the landing gear assembly of a trailer bed of a truck. The control module of the apparatus is located on an accessible location of the trailer bed or truck. The control module is connected to the motor of the apparatus by electrical wires passing through the connection tube according to an embodiment of the present invention.

Another objective of the present invention is to provide an electric lift apparatus that comprises multiple housing units and a control module. Each of the housing units includes a motor, a connection tube, a sleeve, and a battery source. The control module controls movements of all the sleeves of the housing units at a same time and in a same direction. The control module includes multiple control buttons. One of the buttons controls an upper ward lifting movement of the sleeves and another one of the buttons controls a downward movement of the sleeves.

### BRIEF DESCRIPTION OF THE DRAWINGS

FIG. 1 is a schematic view of the electric lift apparatus according to one embodiment of the present invention.

FIG. 2 is a schematic view of the cover plate of the electric lift apparatus according to the embodiment of the present invention.

FIG. 3A is a front view of the sleeve of the electric lift apparatus according to the embodiment of the present invention.

FIG. 3b is a side view of the sleeve of the electric lift apparatus according to the embodiment of the present invention.

FIG. 4 is a schematic view of the connection tube and sleeve of the electric lift apparatus to relate to each other according to the embodiment of the present invention.

FIG. 5 is a schematic view of the connection tube of the electric lift apparatus according to the embodiment of the present invention.

FIG. 6A is a schematic view of the control unit of the control module for the electric lift apparatus according to the embodiment of the present invention.

FIG. 6B is a schematic view of the motherboard of the control module for the electric lift apparatus according to the embodiment of the present invention.

### DETAIL DESCRIPTIONS OF THE INVENTION

All illustrations of the drawings are to be describing selected versions of the present invention and are not intended to limit the scope of the present invention. All references of user or users pertain to either individual or individuals who would utilize the present invention.

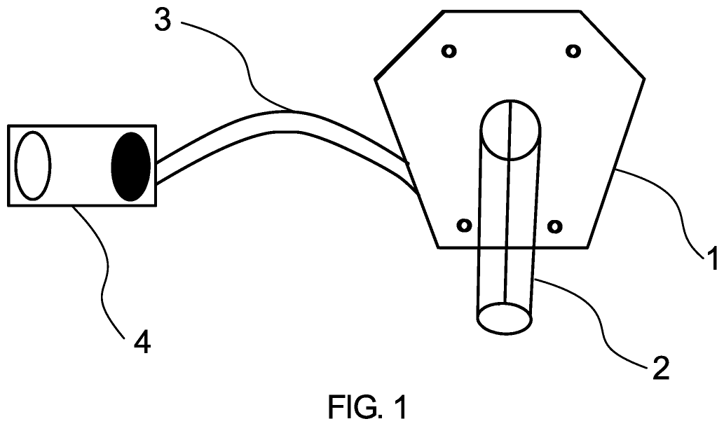

Referring to FIG. 1, the present invention provides an electric lift apparatus for trailer bed legs. The electric lift apparatus of the present invention is preferably located on or near the legs of a trailer bed and/or accessible locations of the trailer bed. The apparatus of the present invention primarily includes a control module and a housing unit.

As seen in FIG. 1, the electric lift apparatus according to one embodiment of the present invention includes a control module 4. The control module is preferably located on an accessible location of the trailer bed of the truck and/or on the truck. According to an alternative embodiment of the present invention, a control panel of the control module 4 is secured by a set of bolts and screws on the lower front panel of the trailer. It is preferred that the control module 4 is of a type or kind such that the user can raise and lift the leg of the trailer bed by interacting with the control module. The control module 4 includes a first button and a second button with either button allowing the user to raise and/or lower a leg of the trailer bed of the truck. The control module 4 may be powered by a battery source. The battery source can be of any type or kind, such as solar panel, rechargeable batteries, and replaceable battery cells, that would allow the present invention to fulfill the objectives and intents of the present invention.

It is preferred that the control module 4 can raise or lower all legs of a trailer bed of a truck at the same time and in the same direction. In another alternative embodiment of the present invention, the control module can include a remote controller such that the user can remotely activate the control module to raise or lower the legs of a trailer bed of a truck.

As seen in FIG. 1, the electric lift apparatus for trailer bed legs includes a housing unit. The housing unit is preferably located or installed at, generally near to, or slightly over the landing gear assembly of a leg of the trailer bed of a truck and/or where a crankshaft would be attached to the landing gear assembly of a leg of the trailer bed of a truck.

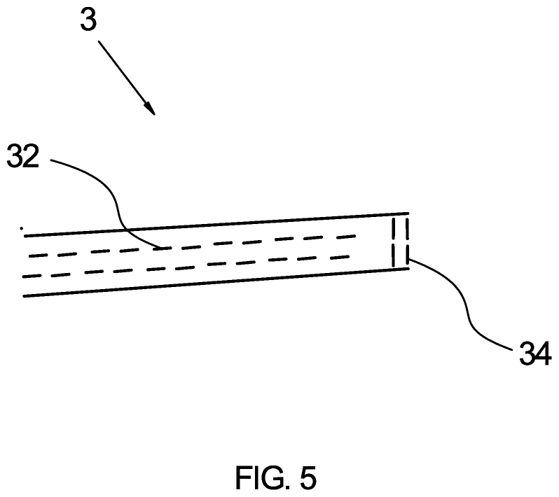

The housing unit primarily includes a motor. The motor can be of any type or kind that would allow the motor to fulfill the objectives and intents of the housing unit. Preferably, the motor is made of a material like and/or compatible with the material of the housing unit. Further, it is preferred that the motor is a dual-directional motor. The motor can be located or fixedly installed near to or slightly above the landing gear assembly of a leg of the trailer bed of a truck and/or where a crankshaft would be attached to the landing gear assembly of a leg of the trailer bed of a truck. The motor includes a driveshaft, which is the connection tube 3 (see FIG. 5) according to the embodiment of the present invention. The driveshaft comprises a first plurality of teeth 34 around the circumference of the driveshaft like that of gears. The control module 4 is connected to the motor by electrical wires passing through the connection tube 3.

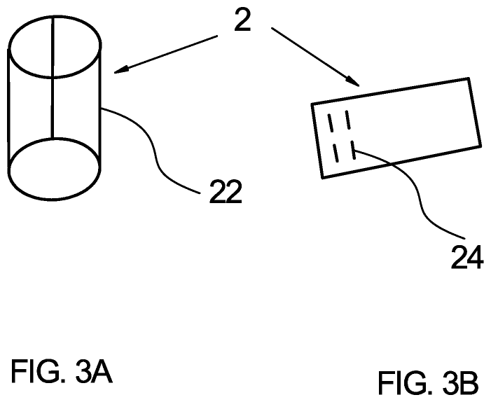

As seen in FIG. 1, the housing unit further includes a sleeve 2 and a cover plate 1. The sleeve 2 can be of any shape, size, and material that would allow the sleeve 2 to fulfill the objectives and intents of the housing unit. Preferably, the sleeve is made of a material like and/or compatible with the material of the housing unit. The sleeve 2 is concentrically attached to a connection rod of the landing gear assembly. Preferably, the sleeve 2 is slipped over the connection rod. The sleeve 2 is further affixed to the connection rod via a set screw or other similar objects. The sleeve 2 includes a second plurality of teeth 24 (see FIG. 3) around the circumference of the sleeve similar to the first plurality of teeth 34 of the connection tube 3 such that the first plurality of teeth 34 of the driveshaft of the gear can mesh with the second plurality of teeth 24 of the sleeve 2. It is preferred that the sleeve is detachable from the connection rod of the landing gear assembly of a leg of the trailer bed of a truck to allow the user to manually raise and lower a leg of the trailer bed of a truck without using a control module.

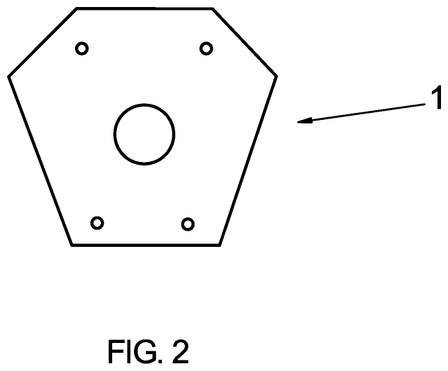

Referring to FIG. 2, there illustrated is the cover plate 1. The cover plate 1 comprises multiple holes and a central hole. The cover plate 1 is attached to the top of the sleeve 2. Thus, the multiple holes could be used for affixing the housing unit of the lift apparatus to the trailer. The central hole is for attaching the sleeve 2 to the cover plate 1. The sleeve 2 may extend beyond the central hole of the cover plate 1 in case that the landing gear needs to be operated manually.

Referring to FIGS. 3A and 3B, there illustrated are front and side views of the sleeve 2, respectively. The sleeve 2 includes a sleeve body 22 and a plurality of teeth 24. The teeth 24 are located on the circumstance of an upper section of the sleeve 2. The connection rod of the landing gear assembly is concentrically fitted into the sleeve body 22 to be supported by the sleeve 2 during lifting operations. Further, the sleeve 2 is affixed to the connection rod via a set screw or other similar objects.

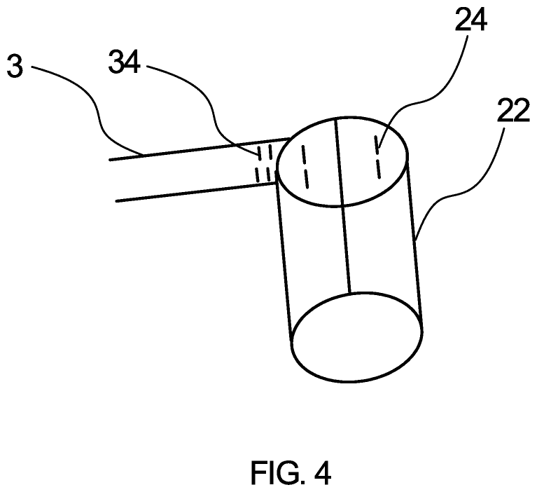

Referring to FIG. 4, there illustrated is a section of the connection tube 3 and the sleeve 2. The connection tube 3 and the sleeve 2 are located behind the cover plate 1. The teeth 34 on the connection tube 3 are to mesh with the teeth 24 of the sleeve 2 so that a rotary motion of the connection tube 3 is converted to a linear motion of the sleeve 2. According to one of the embodiments of the present invention, the sleeve 2 and the connection tube 3 have rack and pinion operations after the teeth 34 on the connection tube 3 are meshed with the teeth 24 of the sleeve 2 to form a linear actuator.

Referring to FIG. 5, there illustrated is the connection tube 3. One end of the tube 3 contains teeth 34 at the tube's external circumstance. Electrical wires 32 passes through central hollow section of the tube 3 to connect the control module 4 with the motor. According to an embodiment of the present invention, the connection tube 3, functioning as a driveshaft, is installed along an inside lip of the trailer.

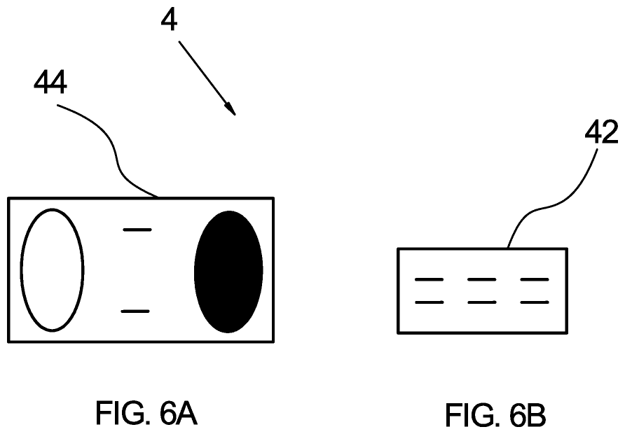

Referring to FIGS. 6A and 6B, there illustrated is a control module 4. The control module 4 comprises a control unit 44 and a mother board 42, where the control unit 44 includes multiple buttons. One of the buttons is for controlling upward movement of the sleeve 2. Another one of the buttons is for controlling downward movement of the sleeve 2. The motherboard 42 is connected electrically to the control unit 44 to provide remote control of the control module 4.

In general, various component parts of the electric lift apparatus according to various embodiments of the present invention, such as the control module, the housing unit, and the motor, can be of any shape, size, material, features, type or kind, orientation, location, quantity, components, and arrangements of components that would allow the present invention to fulfill the objectives and intents of the present invention. However, it is preferred that the component parts are made of materials that are strong, durable, rigid, tough, weather resistant, insular, and/or easily manufacturable.

Although the invention has been explained in relation to its preferred embodiment, it is to be understood that many other possible modifications and variations can be made without departing from the spirit and scope of the invention.

What is claimed is:

1. A portable electric lift apparatus for trailer bed legs, the electric lift apparatus comprising a housing unit and a control module,
wherein the housing unit includes:
a motor,
a battery source electrically connected to the motor,
a connection tube attached to the motor, the connection tube including a first plurality of teeth, and
a sleeve for use to support a connection rod of landing gear assembly of the trailer bed leg, the sleeve including a second plurality of teeth located in circumstances of the sleeve, the first plurality of the teeth meshed with the second plurality of the teeth such that a rotary motion of the connection tube is converted to a linear motion of the sleeve, and
wherein the control module is connected to the motor by electrical wires passing through the connection tube, the control module including multiple control buttons, wherein one of the buttons controls an upper ward lifting movement of the sleeve and another one of the buttons controls a downward movement of the sleeve.

2. The lift apparatus of claim 1 being removable from the trailer.

3. The lift apparatus of claim 1, wherein the sleeve is concentrically attached to the connection rod of the landing gear assembly when in use.

4. The lift apparatus of claim 1, wherein the sleeve comprises a set of screws for use to affix the sleeve to the connection rod of the landing gear assembly.

5. The lift apparatus of claim 1, wherein the control module comprises a control unit and a motherboard, the motherboard configured to remotely control the lift apparatus.

6. The lift apparatus of claim 1, wherein the first plurality of the teeth is meshed with the second plurality of the teeth so that the sleeve is engaged with the connection tube to conduct rack and pinion operations.

7. The lift apparatus of claim 1, wherein the motor is selected from a dual-directional motor.

8. A portable electric lift apparatus for trailer bed legs, the electric lift apparatus comprising multiple housing units, each one of the housing units placed near to one of the trailer bed legs, and a control module,
wherein the housing unit includes:
a motor,
a battery source electrically connected to the motor,
a connection tube attached to the motor, the connection tube including a first plurality of teeth, and
a sleeve for use to support a connection rod of landing gear assembly of the trailer bed leg, the sleeve including a second plurality of teeth located in circumstances of the sleeve, the first plurality of the teeth meshed with the second plurality of the teeth such that a rotary motion of the connection tube is converted to a linear motion of the sleeve, and
wherein the control module is connected to the motor by electrical wires passing through the connection tube, the control module controlling movements of all the sleeves of the housing units at a same time and in a same direction, and the control module including multiple control buttons, wherein one of the buttons controls an upper ward lifting movement of the sleeves and another one of the buttons controls a downward movement of the sleeves.

9. The lift apparatus of claim 8 being removable from the trailer.

10. The lift apparatus of claim 8, wherein the sleeve is concentrically attached to the connection rod of the landing gear assembly when in use.

11. The lift apparatus of claim 8, wherein the sleeve comprises a set of screws for use to affix the sleeve to the connection rod of the landing gear assembly.

12. The lift apparatus of claim 8, wherein the control module comprises a control unit and a motherboard, the motherboard configured to remotely control the lift apparatus.

13. The lift apparatus of claim 8, wherein the first plurality of the teeth is meshed with the second plurality of the teeth so that the sleeve is engaged with the connection tube to conduct rack and pinion operations.

14. The lift apparatus of claim 8, wherein the motor is selected from a dual-directional motor.
